(19) United States
(12) Patent Application Publication
(10) Pub. No.: US 2011/0087685 A1
(43) Pub. Date: Apr. 14, 2011

(54) LOCATION-BASED SERVICE MIDDLEWARE

(75) Inventors: Jyh-Han Lin, Mercer Island, WA (US); Arjun Sundararajan, Bellevue, WA (US)

(73) Assignee: Microsoft Corporation, Redmond, WA (US)

(21) Appl. No.: 12/577,054

(22) Filed: Oct. 9, 2009

(51) Int. Cl. G06F 17/30; G06F 9/46

(52) U.S. Cl. 707/765; 719/328; 707/E17.017

(57) ABSTRACT

A middleware system is provided that is situated between the user applications and the various content databases that are to be searched in order to simplify the creation of user applications for mobile devices that use location-based services that employ ontology-based search systems. The middleware system exposes one or more services to the user application. For example, a service exposes a service that allows the user to annotate and/or tag known semantic locations. As another example, a service provides a list of suggested semantic POIs to user applications in response to user queries. The suggested semantic POIs are selected based on a user's location and possibly context-dependent information. The suggested semantic POIs also may be based on user-dependent information obtained from a user-profile or the like and the suggested semantic locations that are provided to the user applications may be ranked and presented in an order beginning with those semantic locations that may be of greatest interest.

### BACKGROUND

Location-based services (LBS) typically employ applications that integrate many different technologies, including cellular telephone technology (e.g., GSM), wireless networking technologies (e.g., Wi-Fi) and Global Positioning Systems (GPS), as well as other technologies such as sensor networks, radio frequency identifiers (RFID) and the like. Global positioning systems provide location information in terms of geographic coordinates.

Users, however, are usually interested in the meaning of a location rather than in its geographic coordinates. For instance, instead of a geographic coordinate, it may be more meaningful to use, for instance, the name of a hotel or restaurant. A place with a fixed position that is identified by a name rather than by geographic coordinates is referred to as a semantic location. A semantic location may be classified as an example of a semantic Point-of-Interest (POI), which more generally refers to any product, service or place with a fixed position that is identified by a name rather than by geographic coordinates.

### SUMMARY

An LBS framework is provided utilizing a middleware system that is situated between user applications and the various content databases that are to be searched so that the creation of user applications for mobile devices that rely on location-based services using ontology-based search systems can be streamlined by reducing complexity. Location-based services can thus be efficiently provided to users of mobile devices which can determine their own geographic coordinates using a Global Positioning System (GPS) or the like. An interface to the services will typically be provided by an application residing on a mobile device such as a cell phone or an application that is cloud-based (i.e., using a distributing computing model). Such an application enables a device user to query various databases to find semantic locations such as the name of a nearby restaurant, hotel, or other Point-of-Interest (POI). In addition to conventional key-word matching, the user queries may perform context searching by using ontology-based search systems that enable context searching in various domains such as product type domains, service type domains and like.

In various illustrative implementations, the middleware system exposes one or more services to the user application. For example, one such service provides a list of suggested semantic POIs to user applications in response to user queries. The suggested semantic POIs are selected based on a user's location and possibly context-dependent information such as the day and date, the current weather and traffic, the mode of transportation available to the user, and other conditions describing the user's location. In some implementations the suggested semantic POIs also may be based on user-dependent information obtained from a user-profile or the like. In some implementations the suggested semantic locations that are provided to the user applications may be ranked and presented in an order beginning with those semantic locations that may be of greatest interest to the user.

In another illustrative example, the middleware system exposes a service that allows the user to annotate and/or tag known semantic locations. For instance, a semantic location representing a restaurant can be tagged with a photograph of the restaurant or text such as “great Mexican food!” The annotation or tag may be saved in association with a user identifier such as a Windows Live® ID. The annotation or tag may or may not be made available to other users.

The present middleware layer can provide an advantageous reduction in complexity by connecting just once to the mobile service provider's network and the various databases so that application developers can create user applications without concern for the lower level services.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 shows the components of an example of an LBS framework that employs domain-specific ontologies.

FIG. 2 shows a three-tier communication model that may be used as an architecture to technically implement the LBS framework shown in FIG. 1.

FIG. 3 shows one example of the logical architecture of an end-to-end LBS system that employs the three-tier model shown in FIG. 2.

FIG. 4 shows one example of a middleware layer that offers additional services beyond the database query services discussed above in connection with FIG. 3.

FIG. 5 shows one example of an ontology-based query that may be performed by the middleware layer shown in FIG. 4 to identify semantic locations.

### DETAILED DESCRIPTION

A wide variety of mobile devices have reached the market in the past few years which take advantage of new technologies and standardizations. For example, many mobile phones come equipped with web browsers to allow users to perform such tasks as purchasing goods, checking on the status of deliveries, and booking travel arrangements. Mobile devices include any portable device capable of providing data processing and/or communication services to a user. For example, mobile devices include, but are not limited to, portable devices such as cellular telephones, smart phones, display pagers, radio frequency (RF) devices, infrared (IR) devices, Personal Digital Assistants (PDAs), handheld computers, laptop computers, wearable computers, tablet computers, portable e-mail devices, and integrated devices combining one or more of the preceding devices, and the like.

With wider deployment of mobile devices and increased connectivity, interesting new fields such as ubiquitous computing are being developed. Ubiquitous computing, which makes it possible to offer online services to people on the move, wherever they are located, denotes a large spectrum of services, including traditional services such as access to web pages and email. One type of ubiquitous computing services, called “location-based services” (LBS), is becoming increasingly popular as they aim at providing users with “on the spot” information, i.e., information that belongs to a particular domain of interest to the user and which can be of use while the user is at the location from which the LBS is being accessed.

Stated differently, location-based services may be defined as services that integrate a mobile device's location or position with other information so as to provide added value to a user. Such services are typically offered to location-aware mobile devices, which can determine their own geographic locations using a GPS, for example. A common query that a user may pose in the context of LBS is “find the nearest restaurant.” However, LBS can also provide more elaborate information, in particular by taking into account the user's profile and other contextual data.

In order to describe a place, product, or service in terms of a semantic POI it is necessary to understand the particular context of a user's request and the context of a service and data descriptions. Unfortunately, traditional database technology generally ignores context since contextual information has many alternative representations, which make it difficult to use and interpret. Context providers and context consumers may have different understandings of the same contextual information.

One way to address this problem is to use ontologies tailored to provide a shared understanding of the concepts used to describe the context and the data services. In an ontology-based, semantic system, service providers and context providers use domain-specific ontologies to which they commit. These ontologies may include, for instance, a service type ontology (containing concepts such as shop, restaurant), a product ontology (containing concepts such as DVD, vegetarian food), a payment ontology (containing concepts such as cash, credit card), and a context ontology (containing concepts such as location, time).

Application developers are creating numerous user applications that reside on the user's mobile device and which are used to provide the user with location-based services. For instance, one service may display on a map semantic POIs that may be of interest to the user based on the user's current location. Other applications may involve, by way of illustration, tracking, the dissemination of selective information (e.g., advertisements) based on location and location-based games. Because of the complexity involved to integrate geographic position information with differently formatted databases that contain semantic POI information as well as with the mobile service provider's network, a middleware layer or system can be advantageously used to reduce the complexity of service integration.

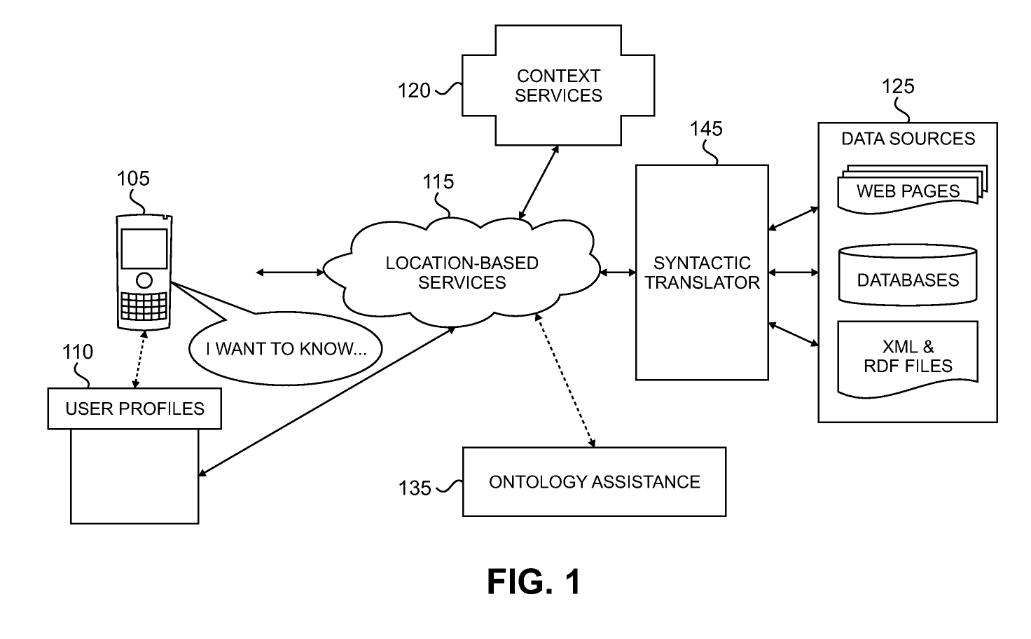

The components of one illustrative LBS framework that employs domain-specific ontologies is shown in FIG. 1. As shown, a mobile device 105 (which may take any of the forms noted above) serves as the interface between the user and the LBS system 115. The mobile device 105 may communicate over a wireless network that can include any system of terminals, gateways, routers, and the like connected by wireless radio links. The wireless network may further employ a plurality of access technologies including 2^{nd} generation (2G), 3rd generation (3G) radio access for cellular systems, WLAN, Wireless Router (WR) mesh, and the like.

Access technologies such as 2G, 3G, and future access networks may enable wide area coverage for mobile devices, such as mobile device 105, with various degrees of mobility. For example, the wireless network may enable a radio connection through a radio network access such as Global System for Mobil communication (GSM), General Packet Radio Services (GPRS), Enhanced Data GSM Environment (EDGE), Wideband Code Division Multiple Access (WCDMA,) and Universal Mobile Telecommunications System (UMTS).

The mobile device 105, in this particular illustrative example, is a location-aware mobile device that includes a device location module that enables the mobile device to determine its own geographic location. In one implementation, the device location module is a GPS receiver, which is capable of updating a device's location on a real or near real-time basis. The location is typically represented in terms of the physical coordinates of the mobile device 105 on the surface of the Earth, which typically outputs a location as latitude and longitude values. The GPS receiver can also employ other geo-positioning mechanisms, including, but not limited to, triangulation, assisted GPS (AGPS), E-OTD, CI, SAI, ETA, BSS or the like, to further determine the physical location of the mobile device 105 on the surface of the Earth.

The mobile device 105 is further configured so that its user can specify and manipulate his or her user profile 110. Each user may have one or more profiles where each user profile may contain one more categories of information including, for instance, factual information (e.g. age, language, and education), preferences and privacy specification. In some cases the user profiles may change and evolve as the context changes. They can be explicitly specified by the user and maintained in a local personal database. The local version of a given user profile also may be used to update user profiles maintained by the LBS system 115.

It should be noted that user information and location information is only collected and stored so that the present LBS framework and middleware layer can enable efficient application utilization of LBS services to enhance the user experience on the mobile device 105. And furthermore, the user and location information is only collected and stored after notice has been provided that the collection of any personal information may occur, for example, when signing up to use the location-based service, and will not be shared with third parties, other than as may be needed to maintain or enhance the quality of the service that is being provided. Other policies that are intended to protect the user's privacy and enhance the quality of the user experience may also be employed. Once the user is informed as to the terms of service, then the user will be given an opportunity to consent to the terms of service.

The LBS system 115 also includes decentralized, remotely located context information service providers 120. Context information includes any information which may determine or influence the selection of information to be returned to the user in response to a given query. This includes information that may lead to a more focused interpretation of a query. Context information generally only refers to information that describes the surrounding environment but not the user or the data in the data stores (i.e., context data is both user-independent and data-independent).

Typical examples of context information include atmospheric data, traffic conditions, calendar data (including national and local holidays), and cultural settings. However, context information may also be defined to include positioning information that is made available to location-aware mobile devices by positioning services, which provide the location of the user's mobile device according to a given format and a precision level (resolution) via the device location module provided in the mobile device. Another example of context information is the mode of transportation (e.g., auto, bus, subway or train) employed by the user.

The data sources 125 are independent and autonomous sources of POI information that the user can query. Illustrative data sources 125 may include virtually any information sources currently accessible over the Internet, including aggregators of data such as aggregators of mapping and traffic information, business data, personal information and government data. Among other things, the data sources 125 publish the contents for each POI that a user may wish to query.

The ontology assistance component 135 of the LBS system 115 provides access to a set of ontologies, each of which may be defined by the LBS system itself or imported from other sources to cover different functionalities. The ontologies may be described by one or more knowledge representation languages such as the Web Ontology Language (OWL) or the Web Service Modeling Ontology (WSMO). In addition, the ontology assistance component 135 may also mediate between different ontologies, e.g. by adding context of ontology using C-OWL, and address c syntactic translation issues between different ontology languages, e.g., between WSMO and OWL. The ontology assistance component 140 is used by the syntactic translator 145 to facilitate access to the data sources, which may each be represented in different syntactic format, e.g., database schema, XML file or web pages.

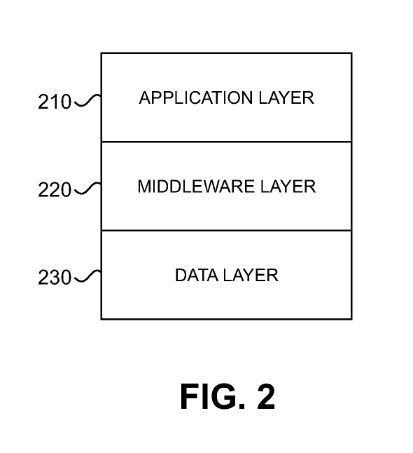

One way to technically implement the LBS framework shown in FIG. 1 can be described by a three-tier communication model such as shown in FIG. 2. The communication model includes a positioning, context and data layer 210, a middleware layer 220 and an application layer 230. The positioning, context and data layer 210 represents all the data that the LBS system may access to respond to user queries. The application layer 230 represents the user interface that translates tasks and results into a form that the user can understand. The middleware layer 220 is a logical layer that coordinates the applications, processes commands, makes logical decisions, and evaluations and performs calculations.

Middleware can generally be described as a communications layer that allows applications and/or components to interact across disparate hardware and network environments. It also moves and processes data between the positioning, context and data layer 210 and the application layer 230. The middleware layer 230 abstracts the details of the underlying positioning, context, and data layer 210 by providing application programming interfaces (APIs) that expose services that may be used by application developers. The APIs may be standardized to further simplify the development and deployment of applications.

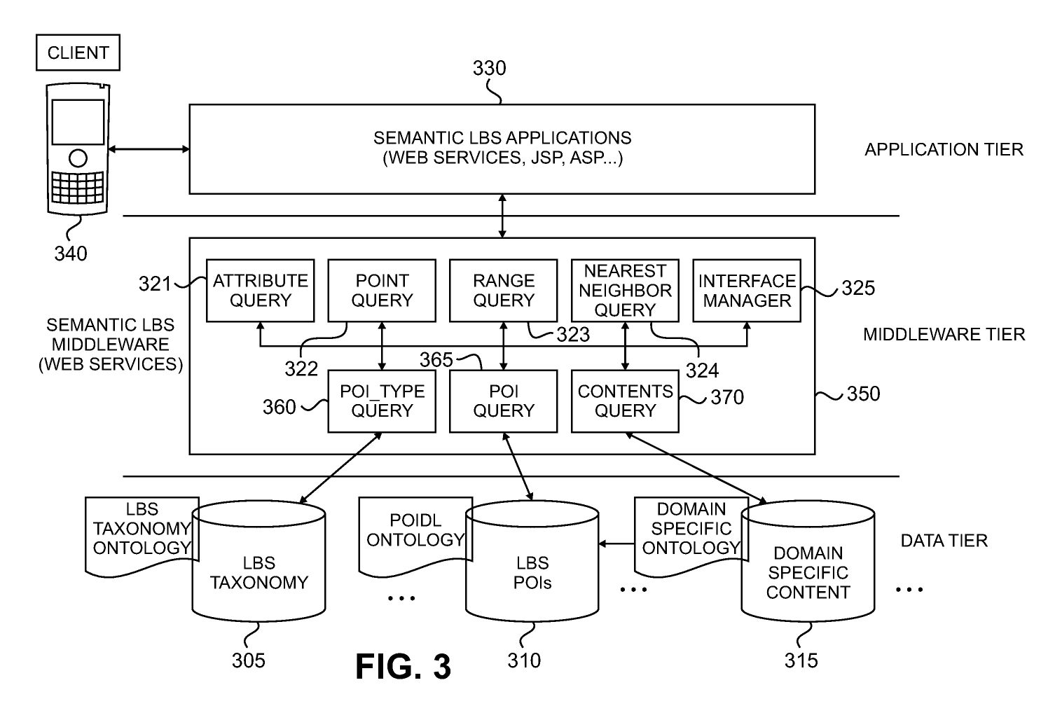

In some cases the LBS middleware may be deployed by a wireless network operator or it may be hosted by an application service provider or a third party. One example of the logical architecture of an end-to-end LBS system showing the various layers or tiers in more detail is presented in FIG. 3.

In this example the data tier is represented by a Geographic Information System (GIS) that includes databases representing LBS taxonomies 305, LBS POIs 310 and domain specific content databases 315 which provide detailed and domain specific information about a POI. These databases allow a POI to be described by information that can be divided into five domains: an attribute domain, space domain, time domain, action domain and a relation domain. The middleware tier or layer 350 can then be implemented as a series of query components 321-324 that can be used to obtain information by performing domain-specific ontology queries in any of these five domains.

For instance, as shown in FIG. 3, an attribute query component 321 is shown, as well as three space domain components: point query component 322, range query component 323 and nearest neighbor query component 324. The attribute query component 321 may return both objective attributes (e.g., POI name, POI activities, POI operating hours) and subject attributes (e.g., satisfaction of service, degree of cleanliness). The point query component 322 returns a POI based on its geographic coordinates. The range query component 323 returns POIs within a certain geographic area. A nearest neighbor query component 324 returns available POIs that are closest to a certain geographic position. Other types of query components are also shown in the middleware layer of FIG. 3, such as a POI query component 360, a POI_Type query component 365, and a contents query component 370.

The middleware layer 350 shown in FIG. 3 acquires the user queries from a user application. The middleware layer also provides the results of the queries as a service that is exposed to the user application 330 via one or more APIs. User applications may be located on the client device (e.g., mobile phone 340) or they may be implemented in whole or in part as cloud-based services. In some cases the middleware may offer enhanced or additional services that can be used by application developers when developing applications.

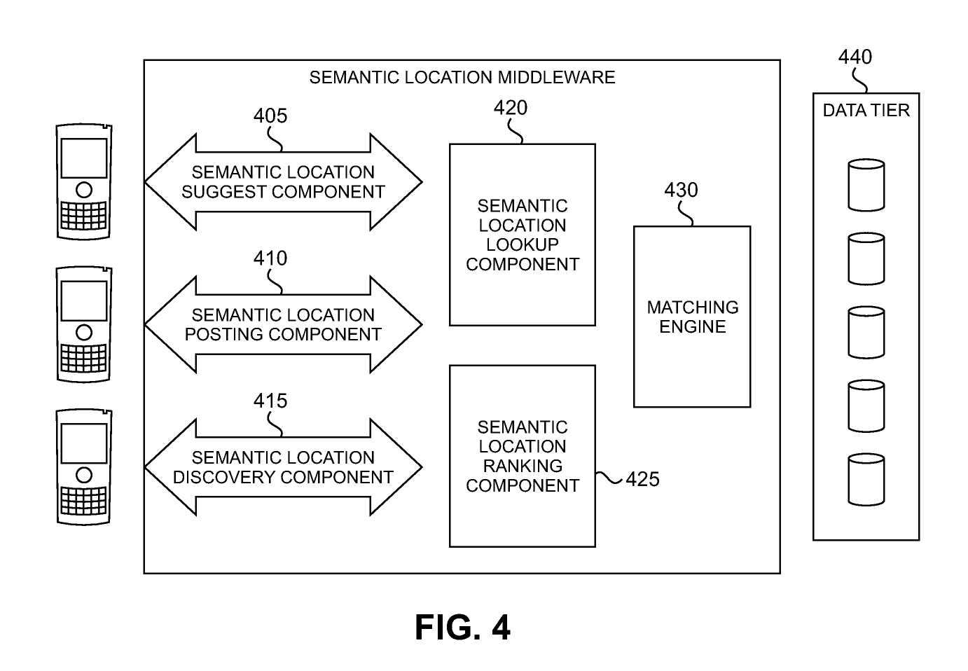

FIG. 4 shows one example of a middleware layer that offers additional services beyond the database query services discussed above in connection with FIG. 3. In this example the additional services are provided by a semantic location suggest component 405, a semantic location posting component 410 and a semantic location discovery component 415.

The semantic location suggest component 405 provides a service that suggests POIs in response to a user query posed via a user application. The user queries are received through a set of APIs and the results are returned to the application though the APIs. The semantic location suggest component 405 passes the user query to the semantic location lookup component 420. This component further develops or refines the user query based on available context information and the user profile.

As a simple example, if for instance a user is searching for restaurants near his or her hotel in San Francisco, the semantic location lookup component 420 may formulate a refined query using contextual information such as physical location, the day of the week and the time of day (to determine from their attributes those nearby restaurants which are currently open) and user profile information (to identify from their attributes, for instance, those restaurants that serve a type of cuisine that the user prefers). Thus, in general, the user query can be further developed or refined based on a variety of factors such as the physical location, the user mobility profile, user history, the mode of transportation, sensor inputs, calendar, contacts, social network membership, and the like.

In the case of sensor inputs, sensor data such as wireless beacon IDs and RF fingerprints from Wi-Fi access points and cellular basestations can also be associated with a number of semantic locations and used as “keys” to recall these semantic locations. For example, the user can associate the Wi-Fi BSSID of a wireless router at the user's home with the semantic tag “My Home,” a set of Wi-Fi BSSIDs with “My Office” or “My Neighborbood,” and so on.

Once the semantic location lookup component 420 has identified all the parameters that are to be considered in formulating the search, the information is passed to the query components of FIG. 3 to search the data tier databases 440. In FIG. 4, the various query components are represented by a matching engine 430, which can pose domain-specific ontology queries. In return, the semantic location suggest component 405 receives from the semantic location lookup component 420 a list of suggested semantic locations from the matching engine 430.

These semantic locations optionally may be passed to a semantic location ranking component 425, which can rank the semantic locations that have been returned in a sequential order beginning with the locations that may be of most interest to the user. The ranking can be accomplished based on many of the same parameters used to define the query. The semantic locations are then passed to the semantic location suggest component 405, which in turn passes them to the user application via a set of APIs.

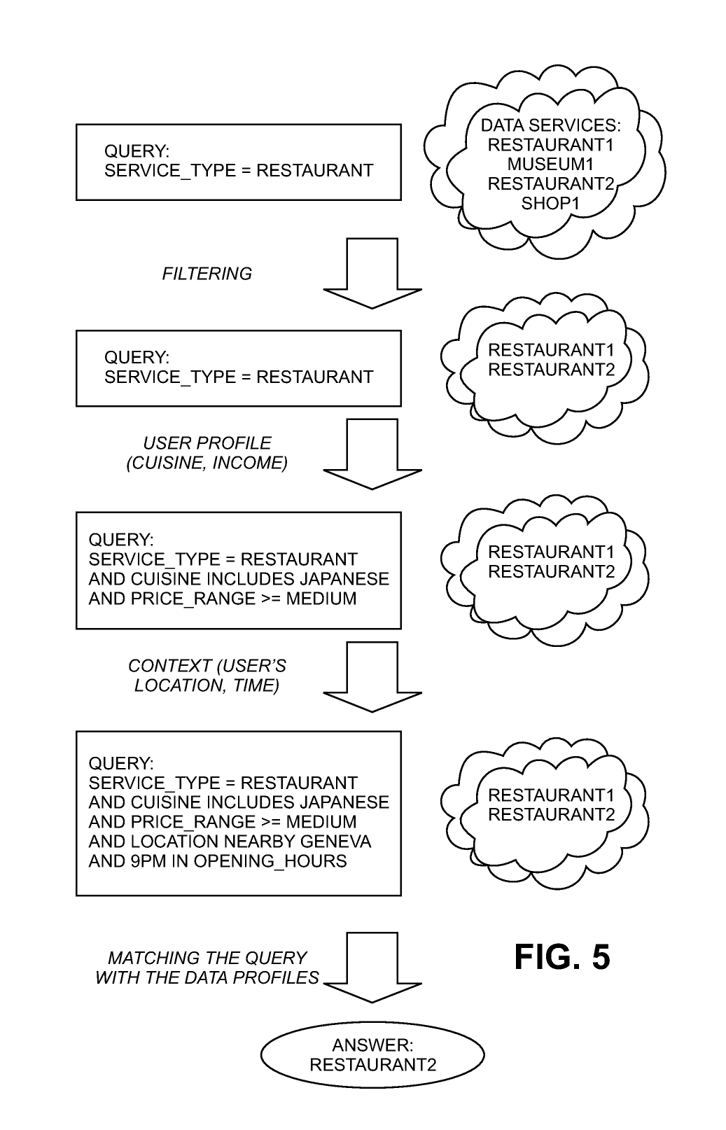

FIG. 5 shows one example of a query that may be performed by the middleware layer shown in FIG. 4. In this example a user application presents a query to the semantic location suggest component 405 requesting a search on the attribute “restaurant.” The query is passed to the semantic location lookup component 420, which examines the user profile to determine the types of food and price ranges that are generally of interest to the user. The semantic location lookup component 420 also identifies relevant contextual information such as the user's location and time of day. Finally, this query is passed to the matching engine 430, which in this example returns the sole semantic location “restuarant2.”

Continuing with the middleware layer shown in FIG. 4, the semantic location discovery component 415 provides a service that presents to user applications semantic locations or other POIs that are newly discovered as the user moves through a physical space. For instance, if the user is moving through a shopping mall this component can discover a particular store. Likewise if the user is moving through an office building, the semantic location discovery component 415 can be used to discover a friend's office.

The semantic location discovery component 415 operates in a manner similar to the semantic location suggest component 405, except that the semantic location discovery component 415 can suggest semantic locations without receipt of a specific user query. Accordingly, the semantic location discovery component 415 may share much of the same infrastructure as the semantic location suggest component. The service offered by this component is exposed to the user applications via the appropriate APIs.

The newly discovered semantic locations that are identified by the semantic location discovery component 415 may be based on some or all of the same criteria employed by the semantic location suggest component 405, such as physical location, the user mobility profile, user history, the mode of transportation, sensor inputs, calendar, contacts, social network membership, and the like. The semantic location discovery component 415 returns its results to the user application via another set of APIs.

Both the semantic location discovery component 415 and the semantic location suggest component 405 may operate in a hierarchical manner. That is, the databases to be searched may be decomposed in multiple dimensions such as spatial, temporal, location taxonomy, and user tasks/intents dimensions, as well as others. Each semantic location within the “range” of the search is scored based on its distance to the user's location in this hyper-dimensional space. As the user moves through the space, the score can be re-evaluated. The list of semantic locations can be ordered by score, with the semantic location with highest score being at the top of the list. Formally, the hyper-dimensional space forms a metric space where a distance measure is defined and distances can be calculated between distinct points in the hyper-space.

The middleware layer shown in FIG. 4 may also include a semantic location posting component 410 that provides a service allowing a user to add a new, personalized attribute or attributes to a known semantic location. These attributes can be objective attributes, such as the attributes “Offices,” “Neighborboods,” or “bowling alleys” and the like, which can be associated with sensor data such as a set of Wi-Fi BSSIDs. Alternatively, these attributes can be subjective attributes that are not already included in the ontology such as an assessment of the wine selection of a restaurant, or the décor of a hotel, for instance. A user identifier (e.g., a Windows Live ID) may be associated with the new attribute.

These attributes may or may not be accessible to other users, depending on the requirements of a particular usage scenario. If they are to be accessible to other users they may be uploaded to the semantic location posting component 410 of the middleware. Alternatively, if they are only to be accessible and searchable by the user who created them (for privacy or other reasons), they may be maintained by a semantic location client resident on the user's mobile device. In this case, the semantic location client may be responsible for merging these newly defined attributes with those obtained from the various databases before the results are presented to the user.

A second service that may be offered by the semantic location tagging component allows a user to generate new semantic location tags to associate with a physical location, area or POI and attach attributes and values to those tags. To generate a new semantic location tag, a well-defined semantic location taxonomy and ontology should be followed so that the tag will conform to a common standard and can be easily shared with other users. By providing a common tagging scheme interoperability can be enhanced across user applications and services.

Typically, a new tag will be generated only if nothing from a suggested list of tags satisfies the user's requirements. For instance, a new tag may be needed, for example, to characterize an area that is outside of the area covered by the LBS system or to characterize a new entity that comes into existence such as a new type of store, for instance. Similar to the attributes, these tags may or may not be accessible to other users. If they are to be accessible to other users they may be uploaded to the semantic location posting component 410 of the middleware. Alternatively, if they are only to be accessible and searchable by the user who created them (for privacy or other reasons), they may be maintained by a semantic location client resident on the user's mobile device. In this case the semantic location client may be responsible for merging these newly defined tags with those obtained from the various databases before the results are presented to the user.

Tagging in this context implies attaching digital text and/or media to a physical location. The tag may refer to a previously defined attribute of a semantic location or POI or an attribute newly defined by the user. For example, through a mobile device the user can tag a physical location that contains a restaurant with the text “great Mexican food.” Users can also use tags that are retrieved via other means such as from kiosks, electronic screens, and/or printed media and the like.

For example, a restaurant might provide a kiosk for a user to retrieve the user's friends' ratings and/or pictures and the like. For ease of use, the user may often add a tag to a location when at that location. Specifically, via the mobile device, the user selects “tag current location,” then enters text and/or other media (e.g., a photo and/or voice tag, etc.). An alternative is that the user can add a tag to a location suggested by the semantic location suggest component of the middleware.

As another example, a user may employ the semantic location posting component 410 to tag POIs in which they often spend time, such as their home or office. When a friend or other contact of the user uses the semantic location suggest component 405 to find one of these POIs, the semantic location posting component will present the friend with a list of tags. The first suggested entry in the tag is likely to be the tag that was entered by the user. If the friend selects this tag instead of creating his or her own, which is likely since it is the first entry in the list, the user and his friend or contact will share the same tag for the same POI. Among other things, this consistent use of the same tag for the same location can simplify subsequent searches by other users.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A location-based service middleware system configured for operation between a user application residing on a mobile device and data sources that include semantic locations or other points-of interest (POIs), the middleware comprising the following computer-implemented components:
a semantic location tagging component for exposing a service to the user application that allows a user of the mobile device to augment semantic locations with personalized information; a semantic location lookup component for receiving a user query posed via the user application and developing a refined query based on the user query, user-dependent information and contextual information available from the mobile device and the data sources; and
a matching engine for querying the data sources based on the refined query developed by the semantic location lookup component.

2. The location-based service middleware system of claim 1 further comprising a semantic location suggest component for exposing a service to the user application that provides a list of suggested semantic locations or other POIs obtained from the data sources in response to the user query posed via the user application, the suggested semantic locations or other POIs being selected based on the user-dependent information and contextual information available from the data sources.

3. The location-based service middleware system of claim 1 in which the personalized information includes attributes and tags.

4. The location-based service middleware system of claim 3 in which the personalized information is associated with a user ID of the user.

5. The location-based service middleware system of claim 1 in which the data sources include data representing location-based service (LBS) taxonomies, LBI, POIs and domain-specific content.

6. The location-based service middleware system of claim 2 in which the semantic location lookup component receives suggested semantic locations from the matching engine in response to the refined query and further comprising a semantic location ranking component for ranking the suggested semantic locations and providing the suggested ranked semantic locations to the semantic location suggest component.

7. The location-based service middleware system of claim 1 further comprising a semantic location discovery component for exposing a service to the user application that provides a list of newly discovered semantic locations or other POIs obtained from the data sources, the suggested semantic locations or other POIs being selected based on the user-dependent information and the contextual information available from the data sources.

8. A hierarchical application programming interface (API) system implemented using computer-executable code stored on one or more computer readable storage media configured for operation between a user application residing on a mobile device and data sources that include semantic locations or other POIs, the application programming interface comprising:
a first set of APIs for exposing a service to the user application that receives user queries from the user application and in response returns suggested semantic locations or other POIs obtained from the data sources; and
a second set of APIs for exposing a service to the user application that allows a user to augment semantic locations with personalized information.

9. The hierarchical application programming interface (API) system of claim 8 further comprising a third set of APIs for exposing a service to the user application that provides to the user application a list of newly discovered semantic locations or other POIs obtained from the data sources, in which the newly discovered semantic locations or other POIs are selected based on user-dependent information as well as contextual information available from the data sources.

10. The hierarchical application programming interface (API) system of claim 8 further comprising.
a semantic location lookup component for receiving the user queries from the first set of APIs and developing a refined query based on the user query, user-dependent information as well as contextual information available from the data sources, and
a matching engine for querying the data sources based on the refined query developed by the semantic location lookup component.

11. The hierarchical application programming interface (API) system of claim 10 further comprising a semantic location ranking component for ranking the suggested semantic locations and providing the suggested ranked semantic locations to the first set of APIs.

12. The hierarchical application programming interface (API) system of claim 8 in which the user-dependent information includes information obtained from a user profile.

13. The hierarchical application programming interface (API) system of claim 11 in which the matching engine poses domain-specific ontology queries.

14. The hierarchical application programming interface (API) system of claim 8 in which the second set of APIs allows the personalized information to be made available to users of other mobile devices.

15. A computer-implemented method for providing location-based services, the method comprising the steps of:
receiving a user query from a user application residing on a mobile device;
refining the user query based at least in part on user-dependent content and contextual information available from a plurality of data sources;
obtaining a list containing at least one semantic location or other POI from at least one of the data sources in response to the refined query; and
exposing a first API to the user application for providing the list to the user application.

16. The computer-implemented method of claim 15 in which refining the user query includes developing a domain specific ontology query.

17. The computer-implemented method of claim 15 further comprising a step of exposing a second API to the user application for providing newly discovered semantic locations or other POIs based on user-dependent information as well as contextual information available from the data sources.

18. The computer-implemented method of claim 15 further comprising a step of exposing a third API to the user application for allowing a user to augment, via the user application, semantic locations or other POIs with personalized information.

19. The computer-implemented method of claim 18 in which exposing the third API includes exposing the third API to the user application for allowing the user to augment the semantic locations with an attribute or tag.

20. The computer-implemented method of claim 19 in which the third API allows the user to selectively determine if the attribute or tag is to be made available to users of other mobile devices.
